(19) United States
(12) Patent Application Publication
(10) Pub. No.: US 2025/0183387 A1
(43) Pub. Date: Jun. 5, 2025

(54) AUTOMATIC PRESSURE ADJUSTMENT DEVICE FOR MEASURING PRESSURIZATION DEMAND OF BATTERY CELLS

(71) Applicant: NATIONAL CHUNG SHAN INSTITUTE OF SCIENCE AND TECHNOLOGY, Taoyuan City (TW)

(72) Inventors: FU-MIN FANG, Taoyuan City (TW); CHI-LIN WU, Taoyuan City (TW); CHIH-HSIEN CHUNG, Taoyuan City (TW); SHIH-CHANG TSENG, Taoyuan City (TW); GWO-HUEI YOU, Taoyuan City (TW); KUO-KUANG JEN, Taoyuan City (TW)

(21) Appl. No.: 18/527,405

(22) Filed: Dec. 4, 2023

(51) Int. Cl. H01M 10/42; G05D 15/01

(52) U.S. Cl. CPC H01M 10/4285; G05D 15/01

(57) ABSTRACT

An automatic pressure adjustment device for measuring the pressurization demand of battery cells includes a linear force output module, a pressing module, and an elastic module. The pressing module includes a pressing plate and a guide rail. The guide rail is parallel to the linear force direction. The pressing plate is moved along the guide rail by the linear force of the linear force output module. The elastic module includes a first plate, a second plate, at least one elastic member, and at least one pressure sensing unit. The first plate and the pressing plate are sandwiched to form a loading space. The plurality of elastic members are disposed between the first plate and the second plate. The compression direction of the plurality of elastic members is along the linear force direction, and the at least one pressure sensing unit is disposed on one side of the second plate.

### BACKGROUND OF THE INVENTION

### 1. Field of the Invention

The present application relates to a battery cell, and more particularly to an automatic pressure adjustment device for measuring the pressurization demand of battery cells.

### 2. Description of the Related Art

Liquid lithium batteries are currently the mainstream batteries used by major electric vehicle manufacturers around the world. Currently, the energy density of liquid lithium batteries is approaching the limit of lithium battery technology. In addition, liquid lithium batteries also have safety concerns.

In order to provide batteries with high safety and functional requirements, solid-state lithium batteries have emerged. Solid-state lithium batteries solve the two fundamental shortcomings of the battery industry, namely safety issues and energy density issues. Solid-state batteries use solid electrolytes to avoid leakage problems. And the solid electrolyte has a strong blocking effect on the positive and negative electrodes, it is less likely to generate lithium dendrites and cause short circuits, so the safety is naturally higher. In addition, due to the safety of solid-state batteries, materials with higher energy density can be used for the positive and negative electrodes, so that the energy density may exceed that of lithium ternary batteries.

However, solid-state lithium batteries also have their limitations. Generally, solid-state batteries are not suitable for rapid charging and discharging. In order to overcome the characteristics of general solid-state batteries that are not suitable for fast charging and discharging, it is theoretically necessary to pressurize the battery units to a certain extent during assembly so that the solid-state batteries can increase the speed of charging and discharging.

However, due to the wide variety of solid-state battery cells, different battery cells will have different pressurization levels due to differences in the types and proportions of materials contained in them. Currently, there is no automated device that can pressurize and measure different battery cells.

### BRIEF SUMMARY OF THE INVENTION

Therefore, in order to solve various problems of battery cells, the present application provides an automatic pressure adjustment device for measuring the pressurization demand of battery cells.

In order to achieve the above objectives and more, the present application provides an automatic pressure adjustment device for measuring the pressurization demand of battery cells, which includes a linear force output module, a pressing module, and an elastic module. The linear force output module is used to generate linear force. The pressing module includes a pressing plate and a guide rail. The guide rail is parallel to the linear force direction of the linear force output module, and the pressing plate is moved along the guide rail by the linear force of the linear force output module. The elastic module includes a first plate, a second plate, at least one elastic member, and at least one pressure sensing unit. The first plate and the pressing plate are sandwiched to form a loading space. The plurality of elastic members are disposed between the first plate and the second plate. The compression direction of the plurality of elastic members is along the linear force direction, and the at least one pressure sensing unit is disposed on one side of the second plate.

In an embodiment of the present application, the automatic pressure adjustment device for measuring the pressurization demand of battery cells further comprises a control module signally connected to the linear force output module, wherein the control module controls the linear force output of the linear force output module.

In an embodiment of the present application, the control module is signally connected to the at least one pressure sensing unit, and the at least one pressure sensing unit transmits a pressure value signal to the control module.

In an embodiment of the present application, the automatic pressure adjustment device for measuring the pressurization demand of battery cells further comprises an electrical measurement module signally connected to the control module, wherein the control module determines the optimal pressure value of a battery cell based on the pressure value signal transmitted by the at least one pressure sensing unit and the electrical data transmitted by the electrical measurement module.

In an embodiment of the present application, the linear force output module includes a force generation unit and a force transmission unit, the force generation unit generates rotational force, and the force transmission unit converts the rotational force into linear force and transmits to the pressing plate.

In an embodiment of the present application, the force generation unit is a motor, the force transmission unit including a gear set and a screw shaft, the gear set is sleeved on a force output shaft of the motor, and the screw shaft is connected to the gear set and the pressure plate.

In an embodiment of the present application, the gear set includes a reducer and at least one spur gear, the reducer is disposed at the force output shaft, and the at least one spur gear is sleeved on the screw shaft and is connected to the reducer.

In an embodiment of the present application, the reducer is a harmonic gear, the harmonic gear is sleeved on the force output shaft, and the at least one spur gear meshes with the harmonic gear.

In an embodiment of the present application, the automatic pressure adjustment device for measuring the pressurization demand of battery cells further comprises a base, wherein the at least one pressure sensing unit is disposed between the second plate and the base.

In an embodiment of the present application, the pressing module further includes at least one guide post, and the at least one guide post penetrates the pressing plate.

Accordingly, the automatic pressure adjustment device for measuring the pressurization demand of battery cells of the present application provides a device that can measure the value of the pressurization demand by different solid-state battery cells during charging and discharging operations. The elastic member provides the linear force output module with sufficient displacement to control the pressure or tension, so the pressure or tension can be accurately controlled.

### BRIEF DESCRIPTION OF THE DRAWINGS

FIG. 1 is a schematic view of the automatic pressure adjustment device for measuring the pressurization demand of battery cells according to an embodiment of the present application.

FIG. 2 is a block diagram of the automatic pressure adjustment device for measuring the pressurization demand of battery cells according to an embodiment of the present application.

### DETAILED DESCRIPTION OF THE INVENTION

To facilitate understanding of the present application, specific embodiments together with the attached drawings for the detailed description of the present application are provided. One skilled in the art may understand objectives, characteristics, and effects of the present application by the contents disclosed in the specification. It should be noted that the present application may also be implemented or applied by other embodiments, and the details in the specification may also be modified and varied based on different views and applications without departing from the spirit of the present application. The following embodiments will further elaborate the relevant technical content of the present application, but the disclosed content is not intended to limit the claims of the present application. The description is as follows:

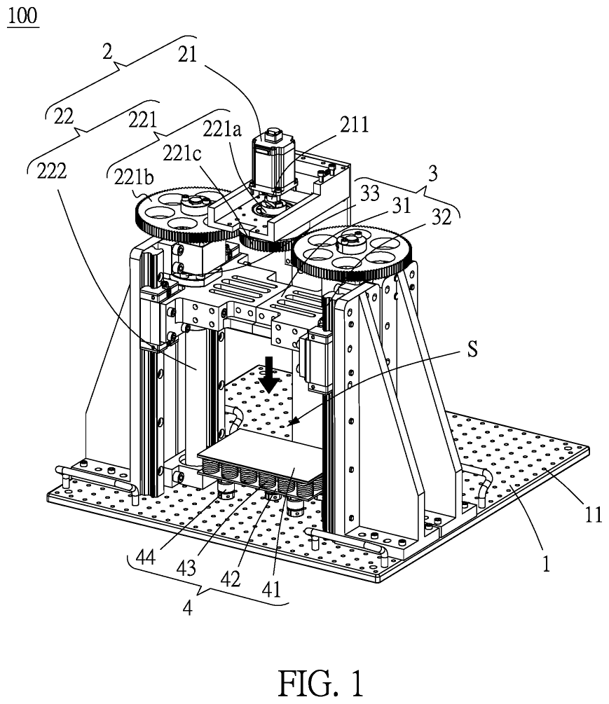

As shown in FIG. 1, an automatic pressure adjustment device for measuring the pressurization demand of battery cells 100 of an embodiment of the present application, comprises a linear force output module 2, a pressing module 3, and an elastic module 4.

The linear force output module 2 used to generate linear force. The linear force output module 2 is such a combination of a motor and a screw shaft, or a hydraulic cylinder. Those mechanisms that can provide reciprocating linear force can be used as the linear force output module 2 of present application.

The pressing module 3 includes a pressing plate 31 and a guide rail 32. The guide rail 32 is parallel to the linear force direction (represented by arrows in FIG. 1) of the linear force output module 2, and the pressing plate 31 is moved along the guide rail 32 by the linear force of the linear force output module 2. In this embodiment, there are two guide rails 32, which are respectively arranged on both sides of the pressing plate 31. The present application does not limit the number of guide rails 32. The guide rails 32 may be provided in greater numbers or only one.

The elastic module 4 includes a first plate 41, a second plate 42, at least one elastic member 43, and at least one pressure sensing unit 44. The first plate 41 and the pressing plate 31 are sandwiched to form a loading space S, wherein the size of the loading space S is variable. The at least one elastic member 43 is disposed between the first plate 41 and the second plate 42, and the compression direction of the at least one elastic member 43 is along the linear force direction. The elastic member 43 is, for example, a spring, but the present application is not limited thereto. Shrapnel, rubber, sponge or other elastic objects can be used as elastic member 43 of this application. The number of elastic member 43 can be provided in plural numbers and dispersedly arranged between the first plate 41 and the second plate 42 to disperse the force from the linear force output module 2.

The at least one pressure sensing unit 44 is disposed on one side of the second plate 42. The at least one pressure sensing unit 44 and the at least one elastic member 43 are located on opposite sides of the second plate 42 respectively. The at least one pressure sensing unit 44 is used to sensing pressure. The pressure sensing unit 44 is such as pressure gauge or pressure sensor. The number of sensing unit 44 can be provided in plural numbers and dispersedly arranged on the second plate 42 to obtain more accurate measurement values.

Next, how to use the automatic pressure adjustment device for measuring the pressurization demand of battery cells 100 of this present application will be described.

First, a battery cell is loaded in the loading space S, that is, between the pressing plate 31 and the first plate 41.

Then, the linear force output module 2 generates linear force to move the pressing plate 31 against the battery cell. The linear force output module 2 can be set to generates the force value or the pressure value. The optimal pressure value setting range is between 1˜10 kgf/cm², and the resolution and accuracy are higher than or equal to 0.1 kgf/cm².

The pressure on the battery cell is sensed by the sensing unit 44, and the electrical performance of the battery cell is measured at the same time. The best electrical performance of the battery cell will be found by providing the varying pressure, and finally the pressurization demand of the battery cell is determined.

During the measurement process, the elastic member 43 allows the battery cell to flexibly change the pressure on the battery cell while stably contacting the pressing plate 31. Through the elastic member 43, the pressure on the battery cell can be better controlled between 0.9 times and 1.1 times the pressure output by the linear force output module 2.

In summary, the automatic pressure adjustment device for measuring the pressurization demand of battery cells 100 of the present application provides a device that can measure the value of the pressurization demand by different solid-state battery cells during charging and discharging operations. The elastic member 43 provides the linear force output module 2 with sufficient displacement to control the pressure or tension, so the pressure or tension can be accurately controlled.

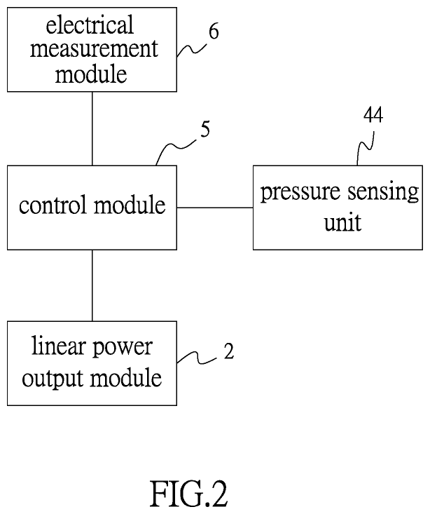

In the present embodiment, as shown in FIG. 2, the automatic pressure adjustment device for measuring the pressurization demand of battery cells 100 further comprising a control module 5 signally connected to the linear force output module 2. The control module 5 is, for example, a control chip or control circuit with logical judgment capabilities, and can be integrated into a computer or a terminal. The control module 5 controls the linear force output of the linear force output module 2. The linear pressure output of the linear force output module 2 can be controlled if the area of the element 31 exerting pressure on the battery cell is preset or known.

Further, in the present embodiment, the control module 5 is signally connected to the at least one pressure sensing unit 44. The at least one pressure sensing unit 44 transmits a pressure value signal to the control module. The pressure value signal includes the pressure value sensing by the pressure sensing unit 44. The control module 5 can further adjust the output of the linear force output module 2 according to the pressure value sensed by the pressure sensing unit 44.

Further, in the present embodiment, the automatic pressure adjustment device for measuring the pressurization demand of battery cells 100 further comprises an electrical measurement module 6 signally connected to the control module 5. The electrical measurement module 6 can detect the electrical performance of a battery cell, such as the voltage and the current of a battery cell. Preferably, the mechanism for charging battery cells and the mechanism for making battery cells discharging are integrated in the electrical measurement module 6. The control module 5 determines the optimal pressure value of a battery cell based on the pressure value signal transmitted by the at least one pressure sensing unit 44 and the electrical data transmitted by the electrical measurement module 6.

Further, in the present embodiment, as shown in FIG. 1, the linear force output module 2 includes a force generation unit 21 and a force transmission unit 22. The force generation unit 21 generates rotational force, and the force transmission unit 22 converts the rotational force into linear force and transmits to the pressing plate 31.

In the present embodiment, the force generation unit is a motor 21. The motor 21 generates rotational force. The motor 21 is such as a servo motor, and the output stroke can be controlled by electrical signals. However, the present application is not limited to this. The force transmission unit 22 includes a gear set 221 and a screw shaft 222. The gear set 221 is sleeved on a force output shaft 211 of the motor 21, and the screw shaft 222 is connected to the gear set 221 and the pressure plate 31.

In the present embodiment, the gear set 221 includes a reducer and at least one spur gear 221b. The reducer is disposed at the force output shaft 211, and the at least one spur gear 221b is sleeved on the screw shaft 222 and is connected to the reducer. The number of spur gear 221b corresponds to the number of the screw shaft 222. The reducer can be any reduction device that applies various mechanical principles to reduce the speed of the motor 21.

In the present embodiment, the reducer is a harmonic gear 221a, the harmonic gear 221a is sleeved on the force output shaft 211, and the at least one spur gear 221b meshes with the harmonic gear 221a directly or indirectly.

In the present embodiment, the harmonic gear 221a indirectly meshes with the spur gear 221b by another spur gear 221c. But in other embodiment, the harmonic gear 221a can meshes with the spur gear 221b directly without the spur gear 221c. The actual composition and application of the gear set 221 may be changed and adjusted as required.

Further, in the present embodiment, the automatic pressure adjustment device for measuring the pressurization demand of battery cells 100 further comprises a base 1. The at least one pressure sensing unit 44 is disposed between the second plate 42 and the base 1. The base 1 has many through holes 11 for screwing other mechanisms, such as the pressure sensing unit 44.

In the present embodiment, the pressing module 3 further includes at least one guide post 33, and the at least one guide post 33 penetrates the pressing plate 31. The at least one guide post 33 is used to assist the pressing plate 31 to move stably.

While the present invention has been described by means of specific embodiments, those skilled in the art should understand the above description is merely embodiments of the invention, and it should not be considered to limit the scope of the invention. It should be noted that all changes and substitutions which come within the meaning and range of equivalency of the embodiments are intended to be embraced in the scope of the invention. Therefore, the scope of the invention is defined by the claims.

What is claimed is:

1. An automatic pressure adjustment device for measuring the pressurization demand of battery cells, comprising:
a linear force output module used to generate linear force;
a pressing module including a pressing plate and a guide rail, wherein the guide rail is parallel to the linear force direction of the linear force output module, and the pressing plate is moved along the guide rail by the linear force of the linear force output module; and
an elastic module including a first plate, a second plate, at least one elastic member, and at least one pressure sensing unit, wherein the first plate and the pressing plate are sandwiched to form a loading space, the plurality of elastic members are disposed between the first plate and the second plate, and the compression direction of the plurality of elastic members is along the linear force direction, and the at least one pressure sensing unit is disposed on one side of the second plate.

2. The automatic pressure adjustment device for measuring the pressurization demand of battery cells according to claim 1, further comprising a control module signally connected to the linear force output module, wherein the control module controls the linear force output of the linear force output module.

3. The automatic pressure adjustment device for measuring the pressurization demand of battery cells according to claim 2, wherein the control module is signally connected to the at least one pressure sensing unit, and the at least one pressure sensing unit transmits a pressure value signal to the control module.

4. The automatic pressure adjustment device for measuring the pressurization demand of battery cells according to claim 3, further comprising an electrical measurement module signally connected to the control module, wherein the control module determines the optimal pressure value of a battery cell based on the pressure value signal transmitted by the at least one pressure sensing unit and the electrical data transmitted by the electrical measurement module.

5. The automatic pressure adjustment device for measuring the pressurization demand of battery cells according to claim 1, wherein the linear force output module includes a force generation unit and a force transmission unit, the force generation unit generates rotational force, and the force generation unit converts the rotational force into linear force and transmits to the pressing plate.

6. The automatic pressure adjustment device for measuring the pressurization demand of battery cells according to claim 5, wherein the force generation unit is a motor, the force transmission unit including a gear set and a screw shaft, the gear set is sleeved on a force output shaft of the motor, and the screw shaft is connected to the gear set and the pressure plate.

7. The automatic pressure adjustment device for measuring the pressurization demand of battery cells according to claim 6, wherein the gear set includes a reducer and at least one spur gear, the reducer is disposed at the force output shaft, and the at least one spur gear is sleeved on the screw shaft and is connected to the reducer.

8. The automatic pressure adjustment device for measuring the pressurization demand of battery cells according to claim 7, wherein the reducer is a harmonic gear, the harmonic gear is sleeved on the force output shaft, and the at least one spur gear meshes with the harmonic gear.

9. The automatic pressure adjustment device for measuring the pressurization demand of battery cells according to claim 1, further comprising a base, wherein the at least one pressure sensing unit is disposed between the second plate and the base.

10. The automatic pressure adjustment device for measuring the pressurization demand of battery cells according to claim 1, wherein the pressing module further includes at least one guide post, and the at least one guide post penetrates the pressing plate.
